(19) United States
(12) Patent Application Publication
(10) Pub. No.: US 2015/0000501 A1
(43) Pub. Date: Jan. 1, 2015

(54) Apparatus for Conveniently Tuning a Guitar String

(71) Applicants: Bobby Duane Rochester, Pacolet, SC (US); Travis Wayne Tucker, Pacolet, SC (US)

(72) Inventors: Bobby Duane Rochester, Pacolet, SC (US); Travis Wayne Tucker, Pacolet, SC (US)

(21) Appl. No.: 14/320,465

(22) Filed: Jun. 30, 2014

Related U.S. Application Data
(60) Provisional application No. 61/840,986, filed on Jun. 28, 2013.

(51) Int. Cl. G10D 3/14

(52) U.S. Cl. CPC G10D 3/14
USPC 84/304

(57) ABSTRACT

An apparatus used to tune a stringed instrument string in a limited time period contains a cap, a spring, and a peg cover. When in use, the apparatus is placed over a tuning peg such that the peg cover encloses the tuning peg. The spring is positioned in between the cap and the peg cover. The cap is placed over the peg cover. Therefore the spring can be compressed by pressing on the cap. The cap contains a tubular portion and a first hole. The hole perpendicularly passes through the tubular portion. The peg cover contains a peg receiving cavity and a second hole. The second hole perpendicularly passes through the peg receiving cavity. When the spring is compressed the first hole and the second hole align with each other. The first hole and the second hole are perimetrically large enough for a stringed instrument string to travel through.

The current application is a non-provisional application and claims a priority to the U.S. provisional patent application Ser. No. 61/840,986 filed on Jun. 28, 2013. The current application is filed on Jun. 30, 2014 while Jun. 28, 2014 was on a weekend.

### FIELD OF THE INVENTION

The present invention relates generally to the music industry. More specifically, the present invention is an apparatus that can be used for tuning a string of stringed instrument efficiently.

### BACKGROUND OF THE INVENTION

The musical instruments we see today are divided into three main categories. Namely, wind instruments, percussion instruments, and string instruments. Wind instruments are musical instruments that include some type of resonator. A user blows air into the mouthpiece located at the end of the resonator. The blowing vibrates a column of air resulting in sound. The flute, the harmonica, and the saxophone are amongst the most famous wind instruments. Percussion instruments are musical instruments that produce sound by striking two bodies together. Different types of drums and keyboards all belong to the category of percussion instruments. The present invention is an apparatus to be used for instruments in the field of string instruments. String instruments are musical instruments that produce sound by vibrating strings. Guitars, violins, violas, and cellos all fall under the category of string instruments. Each of the strings of these instruments is tuned to a different frequency in order to provide different sounds. The strings are tuned by varying the strings' tension because adjusting length or mass per unit length is not practical. For best results, the strings of these instruments need to be tuned on a regular basis. When considering a guitar, guitar nut issues, tuning peg issues, old strings, and poor maintenance are some of the main reasons why the strings need to be tuned or replaced.

Guitars are one of most preferred instruments among musicians worldwide. Guitars are available as electric guitars or acoustic guitars. However, tuning of an electric guitar or an acoustic guitar can be both equally stressful and time consuming. Traditionally, when tuning a guitar or any other comparable stringed instrument, some extra length is left on the string and the string is winded around the tuning peg several times in order to achieve the desired tension. In order to get a pleasing appearance, the string needs to be lined from top to bottom. Such requirements for tuning can be hard to achieve in most instances. As an example, a user may not be able to adjust the tuning within a limited time during a performance if a string breaks and needs to be replaced. Among the existing methods of tuning a guitar and other comparable stringed instruments, locking tuners require a new set of tuners to replace the existing tuners. Due to the mentioned difficulties in tuning, many guitar owners either procrastinate or invest financially in order to get their instruments tuned.

The objective of the present invention is to address the aforementioned issues related to guitars and other comparable stringed instruments. In particular, the present invention introduces an apparatus that can be utilized for tuning guitar strings and other comparable stringed instruments. The present invention eliminates the need to leave extra string length around the tuning peg and also eliminates the need to wrap around the tuning peg multiple times. By utilizing the present invention, a user can tune a guitar string or a string of a comparable stringed instrument conveniently within a short time period. More specifically, the string tuning process which usually takes up to 15 minutes can be shortened to as few as 3 minutes.

### BRIEF DESCRIPTION OF THE DRAWINGS

FIG. 1 is a perspective view of the present invention.

FIG. 2 is a side view of the present invention.

FIG. 3 is a bottom view of the present invention.

FIG. 4 is a perspective view of the cap of the present invention.

FIG. 5 is a side view of the cap of the present invention.

FIG. 6 is a perspective view of the peg cover of the present invention.

FIG. 7 is top view of the peg cover of the present invention.

FIG. 8 is a perspective view of a string installed into the present invention.

FIG. 9 is an exploded view of a string into the present invention.

FIG. 10 is a basic flow chart for the overall usage of the present invention.

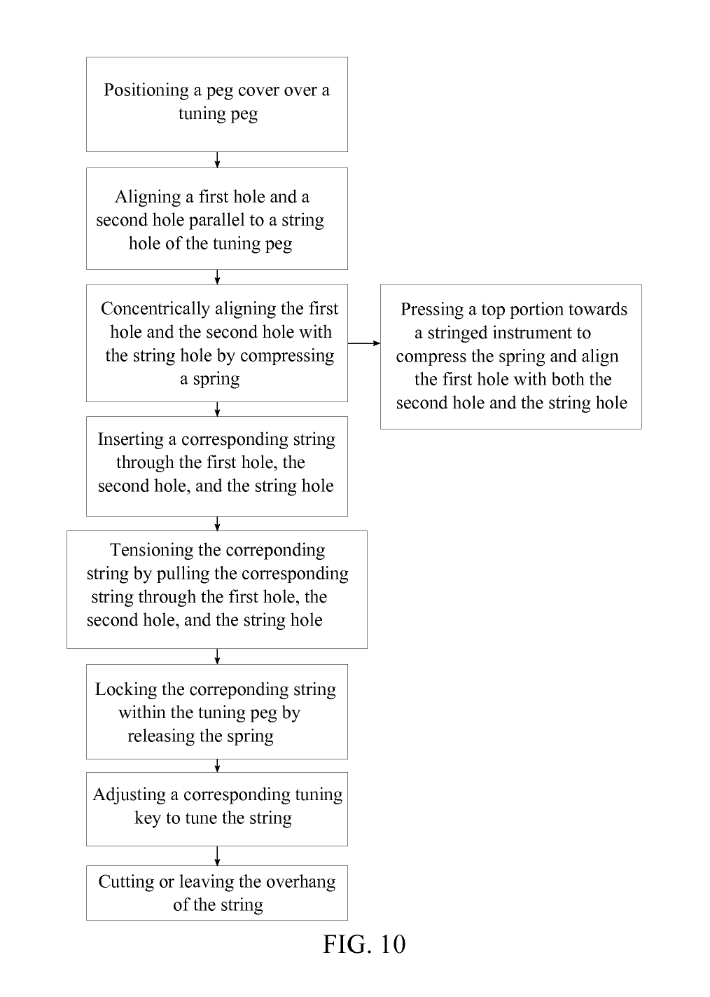

### DETAIL DESCRIPTIONS OF THE INVENTION

All illustrations of the drawings are for the purpose of describing selected versions of the present invention and are not intended to limit the scope of the present invention.

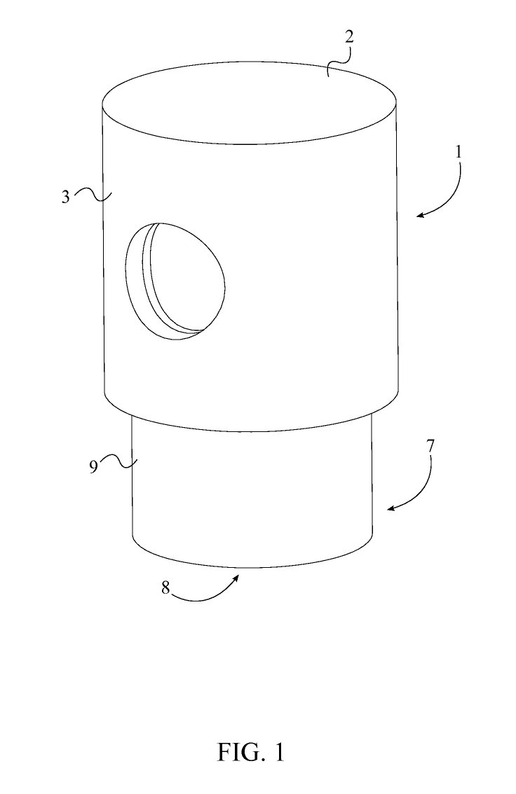

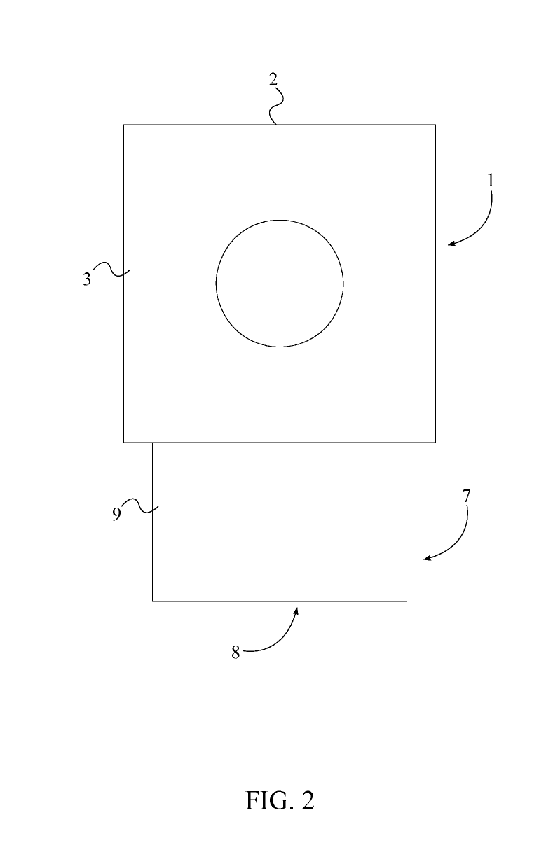

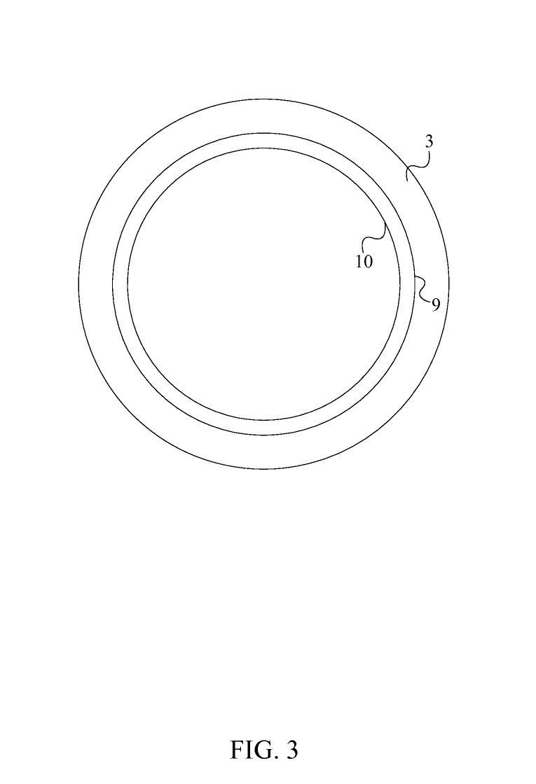

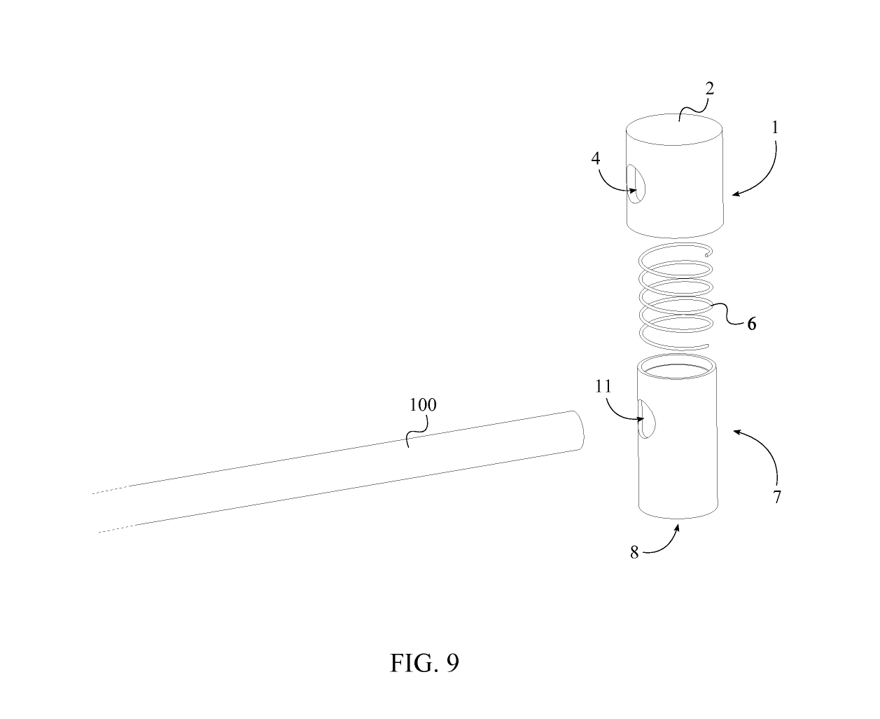

As illustrated in FIGS. 1-9, the present invention is an apparatus that can be utilized to tune guitar strings or strings of a comparable stringed instrument. By utilizing the present invention, a guitar string, or a string of a comparable stringed instrument can be tuned to a desired frequency within a short time period. The present invention comprises a cap 1, a spring 6, and a peg cover 7. The cap 1 and the peg cover 7 are concentrically positioned to each other. Furthermore, the cap 1 and the peg cover 7 are connected to each other with the spring 6 such that the cap 1 is positioned above the peg cover 7. The assembly comprising the cap 1, the spring 6, and the peg cover 7 is placed over a tuning peg. The connection between the cap 1 and the peg cover 7 is utilized to hold a string on a stringed instrument stationary as the spring 6 moves in between an expanded configuration and a compressed configuration, which is vital during the tuning process.

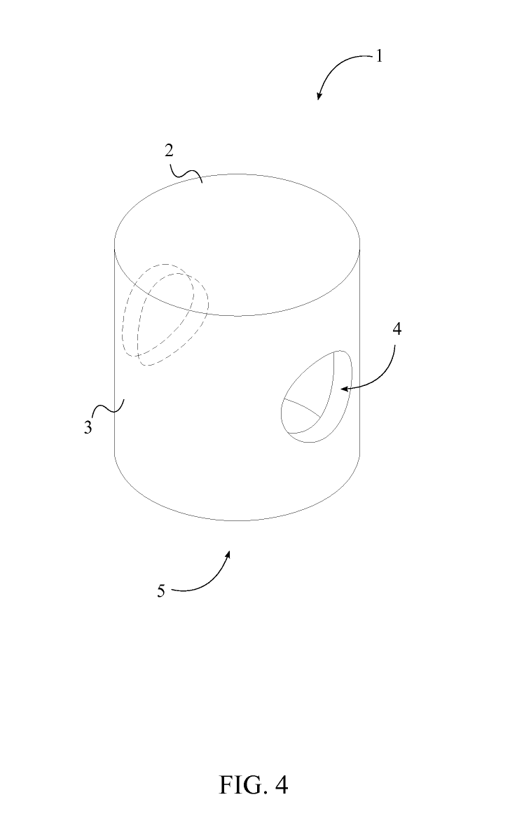

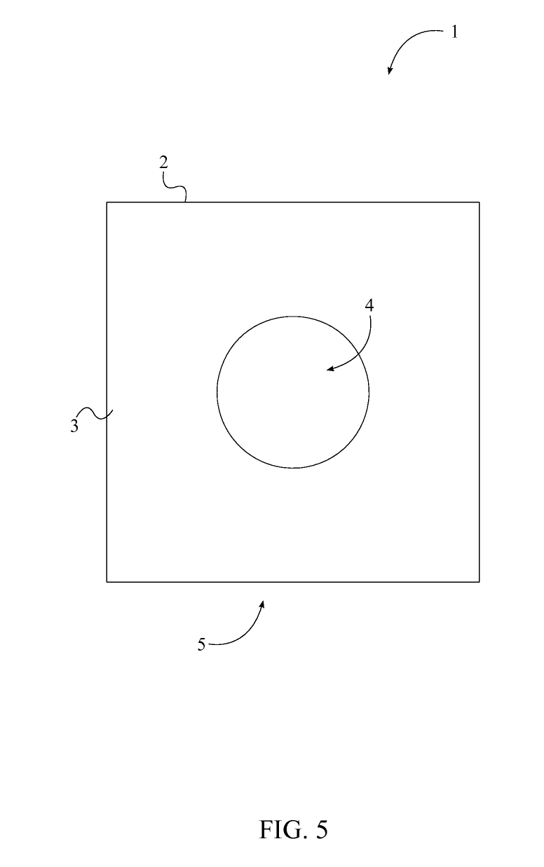

As illustrated in FIG. 4 and FIG. 5, the cap 1 comprises a top portion 2, a tubular portion 3, a bottom opening 5, and a first hole 4. The top portion 2 is perpendicularly positioned with the tubular portion 3 and also perimetrically connected onto the tubular portion 3. The spring 6 is mounted in between the top portion 2 and the peg cover 7 such that pressing on the top portion 2 results in the spring 6 being in its compressed configuration. Furthermore, the spring 6 is concentrically positioned within the tubular portion 3 and also adjacently pressed against the top portion 2 such that the spring 6 can be placed in its compressed configuration with minimum effort. The top portion 2 and the bottom opening 5 are positioned opposite from each other along the tubular portion 3. The peg cover 7 slides into the tubular portion 3 through the bottom opening 5 when the spring 6 is in its compressed configuration. The first hole 4, which allows the stringed instrument string to traverse the cap 1, perpendicularly traverses the tubular portion 3. The first hole 4 provides the necessary opening for the cap 1 in the process of holding the corresponding stringed instrument string stationary.

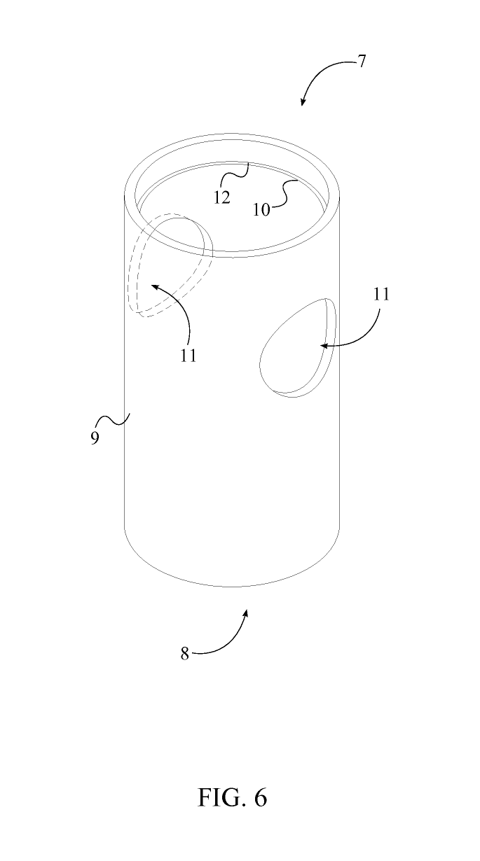

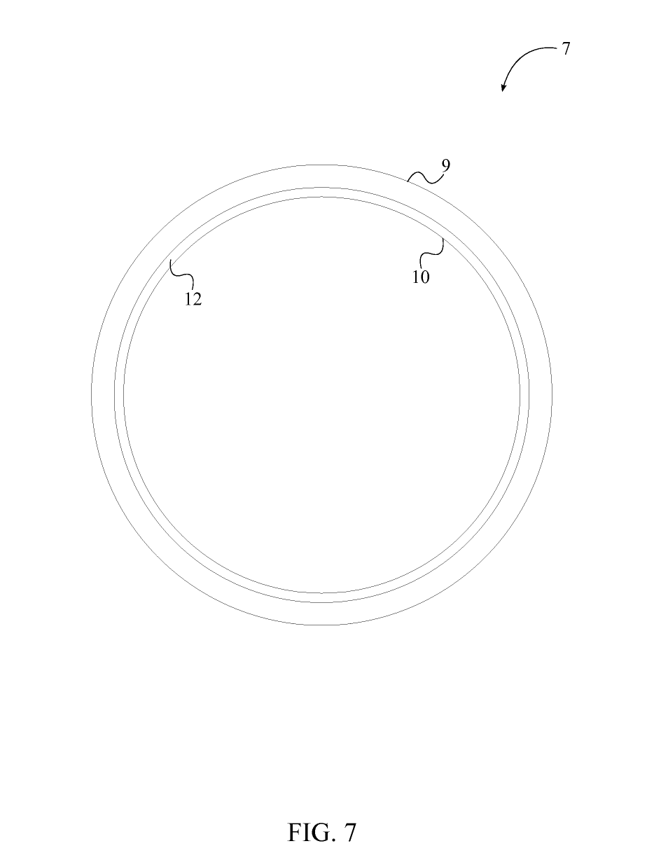

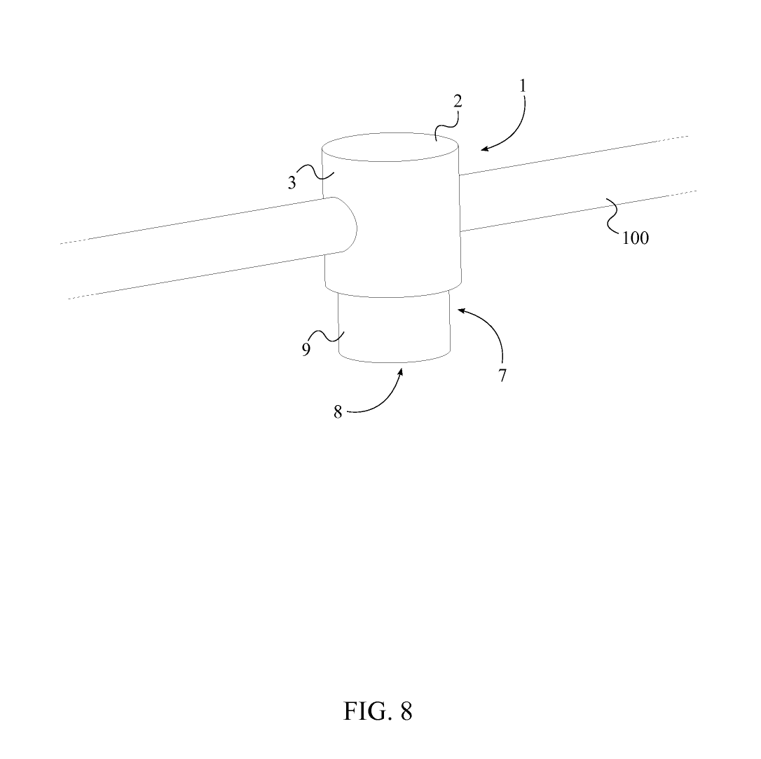

As shown in FIG. 6 and FIG. 7, the peg cover 7 comprises a peg receiving cavity 8, an outer annular surface 9, an inner annular surface 10, and a second hole 11. The peg receiving cavity 8 is delineated by the inner annular surface 10 as the outer annular surface 9 and the inner annular surface 10 are concentrically positioned to each other. When the present invention is placed over the tuning peg, the tuning peg is placed within the peg receiving cavity 8. More specifically, when the cap 1 is placed over the peg cover 7, the outer annular surface 9 is sleeved by and also slidably engaged by the tubular portion 3 as illustrated in FIG. 8. As a result, the cap 1 slides along the outer annular surface 9 when the spring 6 is in its compressed configuration. Similar to the first hole 4 perpendicularly traversing through the cap 1, the second hole 11 also perpendicularly traverses through the peg cover 7. The second hole 11 is also utilized to hold the stringed instrument string stationary during the tuning process. More specifically, the outer annular surface 9 and the inner annular surface 10 are perpendicularly traversed by the second hole 11. The first hole 4 and the second hole 11 are positioned in parallel to each other such that the first hole 4 and the second hole 11 concentrically align with each other in the compressed configuration of the spring 6. A radius of the first hole 4 can be equal to a radius of the second hole 11 such that the first hole 4 and the second hole 11 are perimetrically aligned with each other in the compressed configuration of the spring 6. However, the first hole 4 and the second hole 11 can also differ in radius as long as the radius of the first hole 4 and the second hole 11 is wide enough for a stringed instrument string to traverse through. When the spring 6 is positioned within the expanded configuration, the first hole 4 and the second hole 11 are offset from each other.

The peg cover 7 further comprises a counterbore 12 which traverses into the peg cover 7. The spring 6 is concentrically mounted into the counterbore 12. As a result, the spring 6 adjacently presses against the peg cover 7, opposite to the top portion 2, so that the spring 6 is able to remain stationary between the top portion 2 and the peg cover 7. The spring 6 can be attached to the top portion 2 with attachment means that can be, but is not limited to, spring adhesive.

In utilizing the present invention on a stringed instrument comprising a tuning peg, a corresponding string 100, and a corresponding tuning key, the consequent process flow is followed. First, the peg cover 7 is positioned over the tuning peg. Next, the first hole 4 and the second hole 11 are placed parallel to a string hole of the tuning peg by rotating the present invention in a clockwise or a counterclockwise direction. Afterwards, the first hole 4, the second hole 11, and the string hole are concentrically aligned with each other by placing the spring 6 in its compressed configuration. The top portion 2 is pressed towards the stringed instrument in order to place the spring 6 in its compressed configuration. The corresponding string 100 is then inserted through the first hole 4, the second hole 11, and the string hole. Afterwards, the corresponding string 100 is pulled out through the first hole 4, the second hole 11, and the string hole to provide necessary tension. When the corresponding string 100 has reached the desired amount of tension, the corresponding string 100 is locked in position by releasing the spring 6. The resulting position of the corresponding string 100 and the present invention is illustrated in FIG. 8. More specifically, the corresponding string 100 is locked within the first hole 4, the second hole 11, and the string hole. Whilst the corresponding string 100 is locked within the first hole 4, the second hole 11, and the string hole, the tuning key is adjusted such that the corresponding string 100 can be tuned to a desired frequency. When the corresponding string 100 is tuned to a desired frequency, the overhang of the corresponding string 100 is reduced in length by cutting the corresponding string 100. The same procedure can be performed on the remaining strings of the stringed instrument such that all strings are tuned according to the user's preference.

Although the invention has been explained in relation to its preferred embodiment, it is to be understood that many other possible modifications and variations can be made without departing from the spirit and scope of the invention as hereinafter claimed.

What is claimed is:

1. An apparatus for conveniently tuning a stringed instrument string comprises:
a cap;
a spring;
a peg cover;
the cap comprises a top portion, a tubular portion, and a bottom opening, and a first hole;
the peg cover comprises a peg receiving cavity, an outer annular surface, an inner annular surface, and a second hole;
the first hole perpendicularly traversing through the tubular portion;
the outer annular surface and the inner annular surface being concentrically positioned with each other;
the peg receiving cavity being delineated by the inner annular surface;
the second hole perpendicularly traversing through the outer annular surface and the inner annular surface;
the outer annular surface being sleeved by and slidably engaged to the tubular portion;
the spring being concentrically positioned within the tubular portion;
the spring being mounted in between the top portion and the peg cover; and
the first hole and the second hole being positioned parallel to each other.

2. The apparatus for conveniently tuning a stringed instrument string as claimed in claim 1 comprises:
the peg cover further comprises a counterbore;
the counterbore traversing into the peg cover;
the counterbore being concentrically positioned with the inner annular surface;
the spring adjacently pressing against the top portion;
the spring adjacently pressing against the peg cover, opposite to the top portion; and
the spring being concentrically mounted into the counterbore.

3. The apparatus for conveniently tuning a stringed instrument string as claimed in claim 1, wherein a radius of the first hole is equal to a radius of the second hole.

4. The apparatus for conveniently tuning a stringed instrument string as claimed in claim 1 comprises:
wherein the spring is in a compressed configuration; and
the first hole and the second hole being concentrically aligned with each other.

5. The apparatus for conveniently tuning a stringed instrument string as claimed in claim 1 comprises:
wherein the spring is in an expanded configuration; and
the first hole and the second hole being offset from each other.

6. The apparatus for conveniently tuning a stringed instrument string as claimed in claim 1 comprises:
the top portion being perpendicularly positioned with the tubular portion;
the top portion being perimetrically connected onto the tubular portion; and
the top portion and the bottom opening being positioned opposite of each other along the tubular portion.

7. A method for conveniently tuning a stringed instrument string with the apparatus claimed in claim 1 comprises:
providing a stringed instrument, wherein the stringed instrument includes a tuning peg, a corresponding string, and a corresponding tuning key;
positioning the peg cover over the tuning peg;
aligning the first hole and the second hole parallel to a string hole of the tuning peg by rotating the apparatus;
concentrically aligning the first hole, the second hole, and the string hole with each other by compressing the spring;
inserting the corresponding string through the first hole, the second hold, and the string hole;
tensioning the corresponding string by pulling the corresponding string through the first hole, the second hold, and the string hole;
locking the corresponding string within the tuning peg by releasing the spring; and
adjusting the corresponding tuning key in order to tune the corresponding string.

8. The method for conveniently tuning a stringed instrument string with the apparatus claimed in claim 7, wherein an overhang for the corresponding string is reduced in length by cutting the corresponding string.

9. The method for conveniently tuning a stringed instrument string with the apparatus claimed in claim 7, wherein the top portion is pressed towards the stringed instrument in order to compress the spring and to align the first hole with both the second hole and the string hole.

10. An apparatus for conveniently tuning a stringed instrument string comprises:
a cap;
a spring;
a peg cover;
the cap comprises a top portion, a tubular portion, a bottom opening, and a first hole;
the peg cover comprises a peg receiving cavity, an outer annular surface, an inner annular surface, and a second hole;
the first hole perpendicularly traversing through the tubular portion;
the outer annular surface and the inner annular surface being concentrically positioned with each other;
the peg receiving cavity being delineated by the inner annular surface;
the second hole perpendicularly traversing through the outer annular surface and the inner annular surface;
the outer annular surface being sleeved by and slidably engaged to the tubular portion;
the spring being concentrically positioned within the tubular portion;
the spring being mounted in between the top portion and the peg cover;
the first hole and the second hole being positioned parallel to each other;
the peg cover further comprises a counterbore;
the counterbore traversing into the peg cover;
the counterbore being concentrically positioned with the inner annular surface;
the spring adjacently pressing against the top portion;
the spring adjacently pressing against the peg cover, opposite to the top portion; and
the spring being concentrically mounted into the counterbore.

11. The apparatus for conveniently tuning a stringed instrument string as claimed in claim 10, wherein a radius of the first hole is equal to a radius of the second hole.

12. The apparatus for conveniently tuning a stringed instrument string as claimed in claim 10 comprises:
wherein the spring is in a compressed configuration; and
the first hole and the second hole being concentrically aligned with each other.

13. The apparatus for conveniently tuning a stringed instrument string as claimed in claim 10 comprises:
wherein the spring is in a expanded configuration; and
the first hole and the second hole being offset from each other.

14. The apparatus for conveniently tuning a stringed instrument string as claimed in claim 10 comprises:
the top portion being perpendicularly positioned with the tubular portion;
the top portion being perimetrically connected onto the tubular portion; and
the top portion and the bottom opening being positioned opposite of each other along the tubular portion.
